(19) United States
(12) Patent Application Publication
(10) Pub. No.: US 2022/0057517 A1
(43) Pub. Date: Feb. 24, 2022

(54) METHOD FOR CONSTRUCTING POINT CLOUD MAP, COMPUTER DEVICE, AND STORAGE MEDIUM

(71) Applicant: GUANGZHOU WERIDE TECHNOLOGY LIMITED COMPANY, Guangzhou (CN)

(72) Inventor: Lilong Huang, Guangzhou (CN)

(73) Assignee: GUANGZHOU WERIDE TECHNOLOGY LIMITED COMPANY, Guangzhou (CN)

(21) Appl. No.: 17/419,430

(22) PCT Filed: Dec. 18, 2019
(86) PCT No.: PCT/CN2019/126328

§ 371 Date: Jun. 29, 2021

(30) Foreign Application Priority Data
Dec. 29, 2018 (CN) 201811642897.2

(51) Int. Cl. G01S 17/89

(52) U.S. Cl. CPC G01S 17/89

(57) ABSTRACT

Provided are a method and apparatus for constructing a point cloud map, a computer device and a storage medium. The method includes: acquiring point cloud data and vehicle body sensor data corresponding to the point cloud data, performing fusion processing on the vehicle body sensor data to obtain an optimal estimation state of the vehicle body sensor data and uncertainty information corresponding to the optimal estimation state, and constructing the point cloud map corresponding to the point cloud data according to the optimal estimation state and the uncertainty information corresponding to the optimal estimation state.

This application claims priority to Chinese Patent Application No. 201811642897.2 filed on Dec. 29, 2018 with the CNIPA, the disclosure of which is incorporated herein by reference in its entirety.

### TECHNICAL FIELD

The present application relates to the field of computer technologies, for example, a method and apparatus for constructing a point cloud map, a computer device and a storage medium.

### BACKGROUND

The technology of high definition maps may be applied to the fields of mobile robots and automatic driving, for example, the centimeter-level positioning of mobile robots may be implemented with the cooperation of sensors such as the laser radar (LiDAR) and cameras.

A method for constructing a high definition map in the related art is mainly based on a nonlinear optimization method, a cost function is constructed through a sensor state, and then the cost function is optimized to obtain the high definition map. However, in a scenario with unclear features and a long-term lack of position-sensor measurements, such as a scenario of a long tunnel, nonlinear optimization easily converges to a wrong local solution due to excessive uncertainty of the initial value, thus causing large errors in the constructed high definition map.

### SUMMARY

Base on this, the present application provides a method and apparatus for constructing a point cloud map, a computer device and a storage medium.

The method for constructing the point cloud map includes the steps described below.

Point cloud data and vehicle body sensor data corresponding to the point cloud data are acquired.

Fusion processing is performed on the vehicle body sensor data to obtain an optimal estimation state of the vehicle body sensor data and uncertainty information corresponding to the optimal estimation state.

The point cloud map corresponding to the point cloud data is constructed according to the optimal estimation state and the uncertainty information corresponding to the optimal estimation state.

In an embodiment, the step in which the fusion processing is performed on the vehicle body sensor data to obtain the optimal estimation state of the vehicle body sensor data and the uncertainty information corresponding to the optimal estimation state includes steps described below.

The optimal estimation state of the vehicle body sensor data is obtained through a Bayesian estimation method.

An uncertainty model is established according to the vehicle body sensor data.

The uncertainty information corresponding to the optimal estimation state is obtained according to the uncertainty model by using the Bayesian estimation method.

In an embodiment, the step in which the point cloud map corresponding to the point cloud data is constructed according to the optimal estimation state and the uncertainty information corresponding to the optimal estimation state includes steps described below.

A cost function is constructed by using the optimal estimation state, the uncertainty information corresponding to the optimal estimation state, and a constraint relationship between the point cloud data.

The cost function is optimized by using a nonlinear optimization method to obtain an optimal state of the point cloud data.

The point cloud data is adjusted according to the optimal state of the point cloud data to construct the point cloud map.

In an embodiment, the step in which the cost function is constructed by using the optimal estimation state, the uncertainty information corresponding to the optimal estimation state, and the constraint relationship between the point cloud data includes steps described below.

The optimal estimation state is used as an initial value for matching between the point cloud data, and the cost function is constructed by using the optimal state, the uncertainty information corresponding to the optimal estimation state, and the constraint relationship between the point cloud data.

In an embodiment, the steps in which the optimal estimation state is used as the initial value for the matching between the point cloud data and the cost function is constructed by using the optimal state, the uncertainty information corresponding to the optimal estimation state, and the constraint relationship between the point cloud data include steps described below.

The optimal estimation state corresponding to the point cloud data is used as the initial value. A first cost function is constructed according to a to-be-optimized state, the optimal estimation state corresponding to the point cloud data, and the uncertainty information corresponding to the optimal estimation state.

A second cost function is constructed through to-be-optimized states of two adjacent frames of point cloud data and the uncertainty information corresponding to the optimal estimation state by using the constraint relationship between the point cloud data.

The first cost function and the second cost function are accumulated to obtain the final cost function.

In an embodiment, the vehicle body sensor data includes a vehicle body position, a vehicle body speed, a vehicle body acceleration, a vehicle body angular speed and a vehicle body forward direction speed; the optimal estimation state includes an optimal estimation position and an optimal estimation attitude; the optimal state includes an optimal position and an optimal attitude; and the to-be-optimized state includes a to-be-optimized position and a to-be-optimized attitude.

The apparatus for constructing the point cloud map includes a data acquisition module, a fusion processing module and a construction module.

The data acquisition module is configured to acquire point cloud data and vehicle body sensor data corresponding to the point cloud data.

The fusion processing module is configured to perform fusion processing on the vehicle body sensor data to obtain an optimal estimation state of the vehicle body sensor data and uncertainty information corresponding to the optimal estimation state.

The construction module is configured to construct the point cloud map corresponding to the point cloud data according to the optimal estimation state and the uncertainty information corresponding to the optimal estimation state.

The computer device includes a memory and a processor. The memory is configured to store a computer program. The processor is configured to, when executing the computer program, implement the steps described below.

Point cloud data and vehicle body sensor data corresponding to the point cloud data are acquired.

Fusion processing is performed on the vehicle body sensor data to obtain an optimal estimation state of the vehicle body sensor data and uncertainty information corresponding to the optimal estimation state.

A point cloud map corresponding to the point cloud data is constructed according to the optimal estimation state and the uncertainty information corresponding to the optimal estimation state.

The computer-readable storage medium stores a computer program. The computer program, when executed by a processor, implements the steps described below.

Point cloud data and vehicle body sensor data corresponding to the point cloud data are acquired.

Fusion processing is performed on the vehicle body sensor data to obtain an optimal estimation state of the vehicle body sensor data and uncertainty information corresponding to the optimal estimation state.

A point cloud map corresponding to the point cloud data is constructed according to the optimal estimation state and the uncertainty information corresponding to the optimal estimation state.

According to the method and apparatus for constructing the point cloud map, the computer device and the storage medium described above, the point cloud data and the vehicle body sensor data corresponding to the point cloud data are acquired, the fusion processing is performed on the vehicle body sensor data to obtain the optimal estimation state of the vehicle body sensor data and the uncertainty information corresponding to the optimal estimation state; and the point cloud map corresponding to the point cloud data is constructed according to the optimal estimation state and the uncertainty information corresponding to the optimal estimation state. States of all point cloud data are optimized as a whole according to the uncertainty information, so as to reduce uncertainties of all states and, especially, reduce uncertainties of states in scenarios with a long-term lack of position measurements (such as a tunnel scenario), thus improving the overall positioning accuracy, and significantly reducing high definition map construction errors caused by insufficient positioning accuracy and the long-term lack of position measurement information.

### BRIEF DESCRIPTION OF DRAWINGS

FIG. 1 is a flowchart of a method for constructing a point cloud map according to an embodiment;

FIG. 2 is a flowchart of the step of acquiring uncertainty information according to an embodiment;

FIG. 3 is a flowchart of the step of constructing a point cloud map according to an embodiment;

FIG. 4 is a flowchart of the step of acquiring a cost function according to an embodiment;

FIG. 5 is a block diagram of an apparatus for constructing a point cloud map according to an embodiment;

FIG. 6 is a block diagram of a fusion processing module according to an embodiment;

FIG. 7 is a block diagram of a construction model according to an embodiment;

FIG. 8 is a block diagram of a function construction sub-module according to an embodiment; and

FIG. 9 is an internal structure diagram of a computer device according to an embodiment.

### DETAILED DESCRIPTION

The present application is described below in detail with reference to the drawings and embodiments. It is to be understood that the embodiments described herein are merely intended to explain the present application and not to limit the present application.

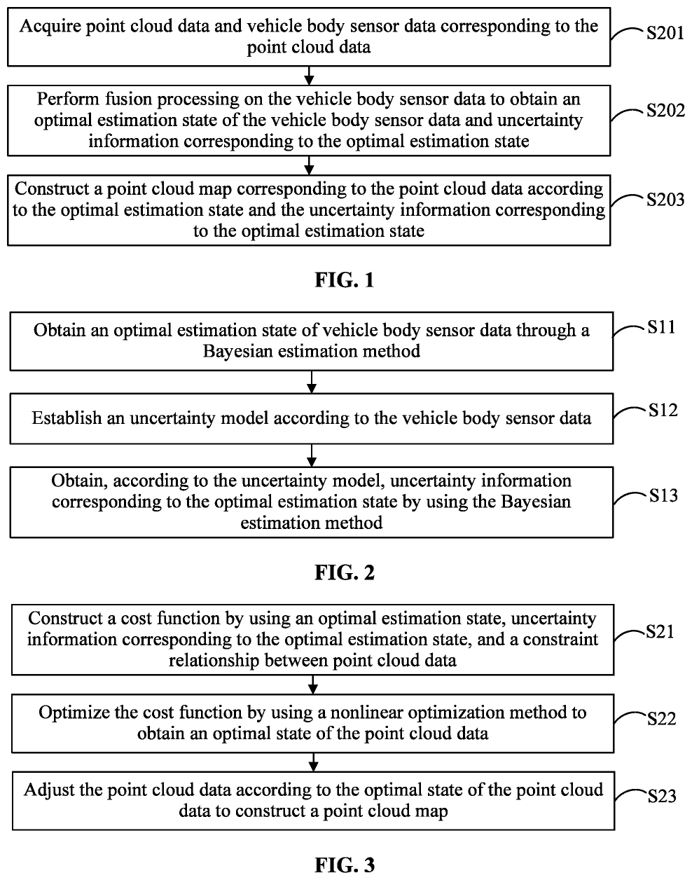

In an embodiment, as shown in FIG. 1, a method for constructing a point cloud map is provided. The method includes the steps described below.

In step S201, point cloud data and vehicle body sensor data corresponding to the point cloud data are acquired.

This embodiment may be applied to a terminal or a server, which is not limited in this embodiment. The terminal may be a personal computer, a notebook computer, a smart phone, a tablet computer and the like. The server may be implemented by an independent server or a server cluster composed of multiple servers. The method may be applied to a positioning scenario of automatic driving or mobile robots.

In this embodiment, the point cloud data and the vehicle body sensor data corresponding to the point cloud data may be acquired firstly. In an example, point cloud data and vehicle body sensor data corresponding to the point cloud data of a point cloud data acquisition vehicle during travel may be acquired. In some embodiments, the point cloud data acquisition vehicle may acquire point cloud data and vehicle body sensor data corresponding to the point cloud data in an environment with a long-term lack of the position measurement of a global positioning system (GPS), such as in a tunnel, a mine and the like.

In view of hardware, the point cloud data acquisition vehicle may include a laser radar (LiDAR) and multiple kinds of sensors.

The multiple sensors may include a GPS unit, an inertial measurement unit (IMU), a wheel speed meter and the like, which are not limited in this embodiment.

The laser radar (LiDAR) may be used for collecting point cloud data. The point cloud data may include spatial three-dimensional coordinate information and reflection intensity information. When the point cloud data acquisition vehicle collects color information through a color image acquisition unit, the point cloud data may further include the color information. The point cloud data may be obtained through the laser radar (LiDAR) and other devices and may be stored in the format of a point cloud (PCD) file.

In another aspect, the GPS unit may be used for collecting a vehicle position and a vehicle speed. The GPS unit refers to the user equipment part of the global positioning system, that is, a GPS signal receiver. The main function of the GPS signal receiver is capturing satellite signals of a to-be-measured satellite selected according to a certain satellite cut-off angle, and tracking the operation of the to-be-measured satellite. After the GPS signal receiver captures the tracked satellite signals, change rates of a pseudo distance and a distance from a receiving antenna to the satellite are measured, and satellite orbit parameters and other data are demodulated. According to the preceding data, a microprocessor in the GPS signal receiver may perform positioning calculation by using a positioning solution method, and the position, the speed, the time and other information about a geographical position where a user is located are calculated. The position may include latitude, longitude and height. In this embodiment, the GPS unit may be installed in the point cloud data acquisition vehicle and used for acquiring a vehicle body position and a vehicle body speed. The vehicle body position may include longitude, latitude and height.

In some embodiments, the IMU may be used for acquiring a vehicle body acceleration and a vehicle body angular speed, and the IMU is an apparatus for measuring an angular speed and an acceleration of an object. Generally, the IMU may include three single-axis accelerometers and three single-axis gyroscopes. The accelerometers detect acceleration signals of an object in three independent axes of a carrier coordinate system. The gyroscopes detect angular speed signals of a vehicle body relative to a navigation coordinate system and measure an angular speed and an acceleration of the vehicle body in the three-dimensional space. In this embodiment, the IMU may be installed in the point cloud data acquisition vehicle and used for acquiring the vehicle body acceleration and the vehicle body angular speed.

In an application, the wheel speed meter may be used for collecting a wheel speed, that is, a vehicle body forward direction speed. The wheel speed meter is a sensor for measuring a vehicle wheel speed. The wheel speed meter has the type mainly including a magnetoelectric wheel speed sensor and a Hall wheel speed sensor.

For example, when the point cloud data acquisition vehicle travels in a long tunnel (for example, in a 3 km tunnel), multiple frames of point cloud data and vehicle body sensor data corresponding to the multiple frames of point cloud data, such as a vehicle body position, a vehicle body speed, a vehicle body acceleration, a vehicle body angular speed, a vehicle body forward direction speed, are collected by the laser radar, the GPS unit, the inertial measurement unit and the wheel speed meter.

In step S202,l fusion processing is performed on the vehicle body sensor data to obtain an optimal estimation state of the vehicle body sensor data and uncertainty information corresponding to the optimal estimation state.

Further applied to this embodiment, the fusion processing is performed on the vehicle body sensor data to obtain the optimal estimation state of the vehicle body sensor data and the uncertainty information corresponding to the optimal estimation state.

The fusion processing may be performed on the vehicle body sensor data by using a multi-sensor data fusion method. The multi-sensor data fusion method corresponds to different algorithms due to different levels of information fusion and may include a weighted average fusion method, a Kalman filter method, a Bayesian estimation method, a probability theory method, a fuzzy logic inference method, an artificial neural network method, a D-S evidence theory method and the like, which are not limited in this embodiment.

In some embodiments, the vehicle body sensor data is input to an algorithm model corresponding to the multi-sensor data fusion method to obtain an outputted optimal estimation state of the vehicle body sensor data. For example, the vehicle body sensor data is used as input of an algorithm model corresponding to the Bayesian estimation method to obtain the outputted optimal estimation state. That is, the vehicle body position, the vehicle body speed, the vehicle body acceleration, the vehicle body angular speed, the vehicle body forward direction speed and the like described above are input to the algorithm model corresponding to the Bayesian estimation method to obtain the outputted optimal estimation state.

Alternatively, the vehicle body sensor data is used as input of an algorithm model corresponding to the Kalman filtering to obtain the outputted optimal estimation state. That is, the vehicle body position, the vehicle body speed, the vehicle body acceleration, the vehicle body angular speed, the vehicle body forward direction speed and the like are input to the algorithm model corresponding to the Kalman filtering to obtain the outputted optimal estimation state.

In some embodiments, for the obtaining manner of the uncertainty information, an uncertainty model is established according to the vehicle body sensor data firstly, then the uncertainty model is combined with the Bayesian estimation method, and the uncertainty information about the vehicle body sensor data is calculated.

It is to be noted that the steps of performing the fusion processing and obtaining the uncertainty information described above may be executed on a hardware device end in an offline manner, thus improving the data processing efficiency and saving data processing resources.

The optimal estimation state may include an optimal estimation position, an optimal estimation attitude, an optimal estimation speed and the like. Since the vehicle body sensor data has a correspondence with the optimal estimation state and also has a correspondence with the point cloud data, the optimal estimation state may be an optimal estimation state corresponding to the point cloud data.

It is to be noted that the vehicle body sensor data required by the fusion processing may include vehicle body sensor data collected by all sensors at all moments. For example, the all moments may be all moments between an acquisition start time point and an acquisition end time point of the point cloud data acquisition vehicle. For example, if the acquisition start time point is moment 1 and the acquisition end time point is moment T, the vehicle body sensor data at all moments from moment 1 to moment T is collected and fused to obtain the optimal estimation state and the uncertainty information corresponding to the optimal estimation state.

In step S203, the point cloud map corresponding to the point cloud data is constructed according to the optimal estimation state and the uncertainty information corresponding to the optimal estimation state.

Practically applied to this embodiment, after the optimal estimation state and the uncertainty information corresponding to the optimal estimation state are obtained, the point cloud map corresponding to the point cloud data is constructed by using the optimal estimation state and the corresponding uncertainty information.

In some embodiments, a cost function is constructed by using the optimal estimation state and the uncertainty information; an optimal state of the point cloud data is obtained by optimizing the cost function, and the point cloud data is adjusted according to the optimal state to construct and obtain the point cloud map.

After the cost function is constructed, the cost function may be optimized by using a nonlinear optimization method to obtain the optimal state of the point cloud data. It is to be noted that the nonlinear optimization method may include gradient descent method, Newton's method, quasi-Newton method, Gauss-Newton method, conjugate gradient method and the like, which are not limited in this embodiment.

The process of optimizing the cost function is an iterative process. The cost function is iterated until the function converges, the optimal state of the point cloud data (which may include an optimal position and an optimal attitude) is obtained, and the operation of constructing the point cloud map from consecutive multiple frames of point cloud data is completed. The iterative process of the cost function is actually a process of continuously adjusting the state (including the position and the attitude) of the point cloud data, the optimal state of the point cloud data is finally obtained, the point cloud data is adjusted according to the optimal state, and the point cloud map is constructed and obtained. After the overall optimization, an accurate high definition map is constructed, for example, when the construction of the high definition map is applied to a tunnel, the construction accuracy of the tunnel map can be apparently improved.

According to the method for constructing the point cloud map, the point cloud data and the corresponding vehicle body sensor data are acquired, the fusion processing is performed on the vehicle body sensor data to obtain the optimal estimation state of the vehicle body sensor data and corresponding uncertainty information; and the point cloud map corresponding to the point cloud data is constructed according to the optimal estimation state and the corresponding uncertainty information. States of all point cloud data are optimized as a whole according to the uncertainty information, so as to reduce uncertainties of all states and, especially, reduce uncertainties of states in scenarios with a long-term lack of the position measurement (such as in a tunnel scenario), thereby improving the overall positioning accuracy, and significantly reducing high definition map construction errors caused by insufficient positioning accuracy and the long-term lack of position measurement information.

In another embodiment, FIG. 2 is a flowchart of the step of obtaining uncertainty information according to this embodiment. The step in which the fusion processing is performed on the vehicle body sensor data to obtain the optimal estimation state of the vehicle body sensor data and the uncertainty information corresponding to the optimal estimation state includes the sub-steps described below.

In sub-step S11, the optimal estimation state of the vehicle body sensor data is obtained through a Bayesian estimation method.

In sub-step S12, an uncertainty model is established according to the vehicle body sensor data.

In sub-step S13, the uncertainty information corresponding to the optimal estimation state is obtained according to the uncertainty model by using the Bayesian estimation method.

In this embodiment, the optimal estimation state of the vehicle body sensor data may be firstly obtained through the Bayesian estimation method. That is, the fusion processing is performed on the vehicle body sensor data through the Bayesian estimation method in the multi-sensor data fusion method to obtain the vehicle body sensor data.

In some embodiments, an optimal estimation state of the vehicle body at each moment is obtained by using all collected vehicle body sensor data through the Bayesian estimation method. The algorithm model corresponding to the Bayesian estimation method is described below.

P(zₖ|y₁:T)

zₖ represents an optimal estimation state (including an optimal estimation position, an optimal estimation speed, an optimal estimation attitude and the like) at moment k. y_{1:T} represents all vehicle body sensor data collected at all moments from moment 1 to moment T. A time period from moment 1 to moment T represents the maximum time length for collecting data. The optimal estimation state such as the vehicle body position and the vehicle body attitude may be obtained through the preceding model.

In some embodiments, the uncertainty model may further be established according to the vehicle body sensor data. The uncertainty model may be a sensor noise model. Sensor noise models of the IMU and the GPS are provided by manufacturers or technical documents. The wheel speed meter identifies the noise model through the collected data, which is not limited in this embodiment.

In a practical application, the uncertainty information corresponding to the optimal estimation state may further be obtained according to the uncertainty model by using the Bayesian estimation method.

In some embodiments, uncertainty information extracted from a covariance matrix may be used as the uncertainty information corresponding to the optimal estimation state.

In another embodiment, FIG. 3 is a flowchart of the step of constructing a point cloud map according to this embodiment. The step in which the point cloud map corresponding to the point cloud data is constructed according to the optimal estimation state and the uncertainty information corresponding to the optimal estimation state includes the sub-steps described below.

In sub-step S21, a cost function is constructed by using the optimal estimation state, the uncertainty information corresponding to the optimal estimation state, and a constraint relationship between the point cloud data.

In sub-step S22, the cost function is optimized by using a nonlinear optimization method to obtain an optimal state of the point cloud data.

In sub-step S23, the point cloud data is adjusted according to the optimal state of the point cloud data to construct the point cloud map.

Practically applied to this embodiment, the cost function is firstly constructed by using the optimal estimation state, the corresponding uncertainty information, and the constraint relationship between the point cloud data; then the cost function is optimized by using the nonlinear optimization method to obtain the optimal state of the point cloud data; after that, the point cloud data is adjusted according to the optimal state of the point cloud data to construct the point cloud map.

After the cost function is constructed, the cost function may be optimized by using the Gauss-Newton method in the nonlinear optimization method, and the optimal state of the point cloud data is obtained.

That is, the cost function is iterated by using the Gauss-Newton method until the function converges, and the optimal state of the point cloud data is obtained, where the optimal state may include the optimal position and the optimal attitude, and the operation of constructing the point cloud map by the point cloud data is completed. After the iterative process of the cost function, the optimal state of the point cloud data is finally obtained, the point cloud data is adjusted according to the optimal state, and the point cloud map is constructed and obtained. After the overall optimization, an accurate high definition map is constructed, for example, when the construction of the high definition map is applied to a scenario with a long-term lack of the position measurement, the construction accuracy of the map in the corresponding scenario can be apparently improved.

In another embodiment, the sub-step in which the cost function is constructed by using the optimal estimation state, the uncertainty information corresponding to the optimal estimation state, and the constraint relationship between the point cloud data includes that the optimal estimation state is used as an initial value for matching between the point cloud data, and the cost function is constructed by using the optimal state, the uncertainty information corresponding to the optimal estimation state, and the constraint relationship between the point cloud data.

In some embodiments, the optimal estimation state may be used as the initial value for the matching between the point cloud data, and the cost function may be constructed by using the optimal state, the uncertainty information corresponding to the optimal estimation state, and the constraint relationship between the point cloud data. That is, the preceding zk is used as the initial value for the matching between the point cloud data, and the cost function is constructed by using the optimal state, the uncertainty information corresponding to the optimal estimation state, and the constraint relationship between the point cloud data.

In another embodiment, FIG. 4 is a flowchart of the step of obtaining a cost function according to this embodiment. The step in which the optimal estimation state is used as the initial value for the matching between the point cloud data and the cost function is constructed by using the optimal state, the uncertainty information corresponding to the optimal estimation state, and the constraint relationship between the point cloud data includes the sub-steps described below.

In sub-step S31, the optimal estimation state corresponding to the point cloud data is used as the initial value, and a first cost function is constructed according to a to-be-optimized state, the optimal estimation state corresponding to the point cloud data, and the uncertainty information corresponding to the optimal estimation state.

In sub-step S32, a second cost function is constructed through to-be-optimized states of two adjacent frames of point cloud data and the uncertainty information corresponding to the optimal estimation state by using the constraint relationship between the point cloud data.

In sub-step S33, the first cost function and the second cost function are accumulated to obtain the final cost function.

In an application, firstly, the first cost function is constructed. The optimal estimation state corresponding to the point cloud data is used as the initial value. The first cost function may be constituted according to the to-be-optimized state, the optimal estimation state corresponding to the point cloud data, and the uncertainty information corresponding to the optimal estimation state.

In some embodiments, the first cost function may be ek(xk, zk)T 6ek(xk, zk). zk denotes the preceding optimal estimation state. xk denotes the preceding to-be-optimized state. Ω denotes a weighted coefficient, and the weighted coefficient is the reciprocal of the uncertainty. Function ek(xk, zk) represents a constraint relationship (that is, an error function) between xk and zk, where k represents a serial number of a point cloud or an acquisition moment of each frame of point cloud data. An initial value of each frame of point cloud data in the East-North-Up (ENU) coordinate system is the preceding zk. The first cost function may make positions and attitudes of each two frames of point cloud data roughly align with each other after translation and rotation of initial values.

In some embodiments, a second cost function may further be constructed according to uncertainty information corresponding to the to-be-optimized states of two adjacent frames of point cloud data through a constraint relationship between point cloud data in the same region.

The second cost function may be ek(xk, zk-1)TΩek(xk, zk-1). xk may denote a to-be-optimized state of one of two adjacent frames of point cloud data. xk-1 denotes a to-be-optimized state of the other one of the two adjacent frames of point cloud data. Ω denotes a weighted coefficient, and the weighted coefficient is the reciprocal of uncertainty. The second cost function may fine-tune relative translation (that is, adjusting positions) and relative rotation (that is, adjusting attitudes) of two adjacent frames of point cloud data through the constraint relationship between the two adjacent frames of point cloud data in the same region, so as to implement the best matching between the two frames of point cloud data.

Then the first cost function and the second cost function are accumulated to complete the construction of the cost function and obtain the final cost function. After the construction of the overall final cost function is completed, an optimization is performed by using the nonlinear optimization method (such as the Gauss-Newton method), so as to minimize the overall cost function and obtain the optimal state of the point cloud data. The point cloud data is adjusted according to the optimal state of the point cloud data to complete the construction of the point cloud map.

F(x) in formula 1 described below represents the final cost function, which represents that the first cost function and the second cost function are accumulated to construct and obtain the final cost function. x* in formula 2 described below represents the optimal state, that is, the optimal position and the optimal attitude of each frame of point cloud data, when the final cost function is minimum.

$$\begin{matrix}F ( x ) = {\sum }_{k ∈ c} \underbrace{{{e}_{k} ( {x}_{k} , {z}_{k} )}^{T} Ω {e}_{k} ( {x}_{k} , {z}_{k} )}_{{F}_{k}} & Formula 1 \\ {x}^{*} = {arg min}_{x} F ( x ) & Formula 2\end{matrix}$$

In formula 1 and formula 2, zₖ denotes the preceding optimal estimation state, xₖ denotes the preceding to-be-optimized state, Ω denotes a weighted coefficient and the weighted coefficient is the reciprocal of uncertainty, function eₖ(xₖ, zₖ) represents a constraint relationship (that is, an error) between xₖ and zₖ, k represents a serial number of a point cloud or an acquisition moment of each frame of point cloud data, F(x) represents the final cost function, and x* represents the optimal state when the final cost function is minimum.

It is to be noted that the first cost function and the second cost function described above are constructed step by step, however, in an application, the final cost function may be constructed simultaneously according to both the first cost function and the second cost function through an application program, and the preceding step-by-step construction is to better explain the construction process of the final cost function in this embodiment.

In order for those having ordinary skill in the art to better understand this embodiment, an example is described below.

1. A point cloud data acquisition vehicle collects three frames of point cloud data and vehicle body sensor data corresponding to the point cloud data.

2. Fusion processing is performed on the vehicle body sensor data through the multi-sensor data fusion method, and an optimal estimation state and corresponding uncertainty information are obtained.

3. The optimal estimation state is used as an initial value, and first cost functions of the three frames of point cloud data are constructed according to to-be-optimized states, the optimal estimation state corresponding to the point cloud data, and the corresponding uncertainty information. The first cost functions of the three frames of point cloud data may include e1(x1, z1)TΩe1(x1, z1), e2(x2, z2)TΩe2(x2, z2), and e3(x3, z3)TΩe3(x3, z3).

4. Second cost functions of the three frames of point cloud data are constructed through to-be-optimized states of two adjacent frames of point cloud data and the corresponding uncertainty information. The second cost functions of the three frames of point cloud data may include e2(x2, x1)TΩe2(x2, x1) and e3(x3, x2)TΩe3(x3, x2).

5. The first cost functions and the second cost functions are accumulated to obtain the final cost function. That is, F(x) is the sum of e1(x1, z1)TΩe1(x1, z1), e2(x2, z2)TΩe2(x2, z2), e3(x3, z3)TΩe3(x3, z3), e2(x2, x1)TΩe2(x2, x1), and e3(x3, x2)TΩe3(x3, x2).

6. The final cost function F(x) is optimized according to the Gauss-Newton method to minimize the overall cost function and obtain the optimal state of the point cloud data. Then, the point cloud data is adjusted according to the optimal state of the point cloud data, so as to complete the construction of the point cloud map.

In another embodiment, the vehicle body sensor data includes a vehicle body position, a vehicle body speed, a vehicle body acceleration, a vehicle body angular speed and a vehicle body forward direction speed; the optimal estimation state includes an optimal estimation position and an optimal estimation attitude; the optimal state includes an optimal position and an optimal attitude; and the to-be-optimized state includes a to-be-optimized position and a to-be-optimized attitude.

It is to be noted that in the step in which the fusion processing is performed on the vehicle body sensor data to obtain the optimal estimation state of the vehicle body sensor data and the uncertainty information corresponding to the optimal estimation state, the obtained optimal estimation state may include the optimal estimation position, the optimal estimation attitude, the optimal estimation speed and the like. However, for the construction of the point cloud map, the final cost function may be constructed merely through the optimal estimation position, the optimal estimation attitude and the uncertainty information corresponding to the optimal estimation state. That is, for the process of constructing the point cloud map by the point cloud data, it is feasible to merely concern the position and the attitude without concerning the speed, the final cost function is optimized and thus the construction of the point cloud map is completed.

It is to be understood that although multiple steps in each flowchart of FIGS. 1 to 4 are illustrated sequentially and indicated by arrows, the steps are not necessarily performed sequentially in the sequence indicated by the arrows. Unless expressly stated herein, there is no strict limitation to the sequence for performing the steps, and the steps may be performed in other sequences. Moreover, at least a part of the steps in FIGS. 1 to 4 may include multiple sub-steps or multiple stages. These sub-steps or stages are not necessarily performed at the same moment, but may be performed in different moments. These sub-steps or stages are also not necessarily performed sequentially, but may take turns with at least a part of sub-steps or stages of other steps, or may be performed alternately with at least a part of sub-steps or stages of other steps.

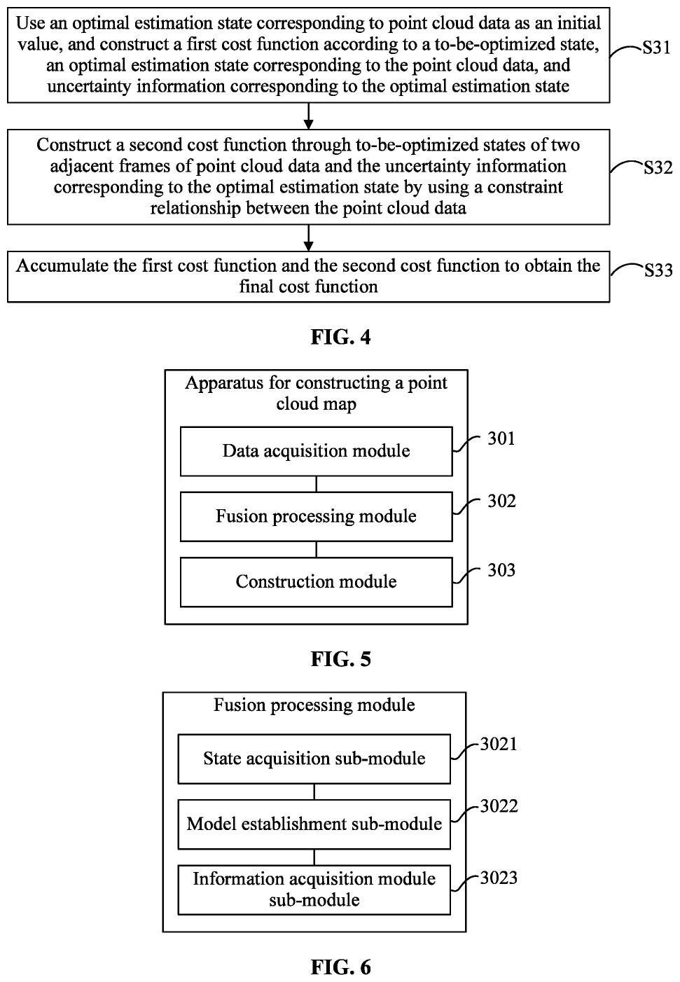

In an embodiment, as shown in FIG. 5, an apparatus for constructing a point cloud map is provided. The apparatus includes a data acquisition module 301, a fusion processing module 302 and a construction module 303.

The data acquisition module 301 is configured to acquire point cloud data and vehicle body sensor data corresponding to the point cloud data.

The fusion processing module 302 is configured to perform fusion processing on the vehicle body sensor data to obtain an optimal estimation state of the vehicle body sensor data and uncertainty information corresponding to the optimal estimation state.

The construction module 303 is configured to construct the point cloud map corresponding to the point cloud data according to the optimal estimation state and the uncertainty information corresponding to the optimal estimation state.

In an embodiment, FIG. 6 is a block diagram of a fusion processing module 302 according to this embodiment. The fusion processing module 302 includes a state acquisition sub-module 3021, a model establishment sub-module 3022 and an information acquisition sub-module 3023.

The state acquisition sub-module 3021 is configured to obtain the optimal estimation state of the vehicle body sensor data through a Bayesian estimation method.

The model establishment sub-module 3022 is configured to establish an uncertainty model according to the vehicle body sensor data.

The information acquisition sub-module 3023 is configured to obtain the uncertainty information corresponding to the optimal estimation state according to the uncertainty model by using the Bayesian estimation method.

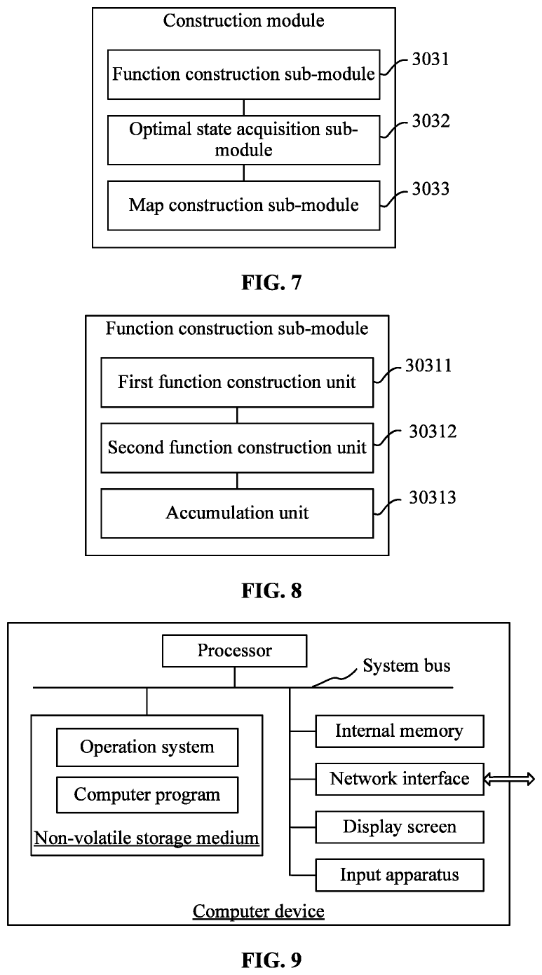

In an embodiment, FIG. 7 is a block diagram of a construction module 303 according to this embodiment. The construction module 303 includes a function construction sub-module 3031, an optimal state acquisition sub-module 3032 and a map construction sub-module 3033.

The function construction sub-module 3031 is configured to construct a cost function by using the optimal estimation state, the uncertainty information corresponding to the optimal estimation state, and a constraint relationship between the point cloud data.

The optimal state acquisition sub-module 3032 is configured to optimize the cost function by using a nonlinear optimization method to obtain the optimal state of the point cloud data.

The map construction sub-module 3033 is configured to adjust the point cloud data according to the optimal state of the point cloud data to construct the point cloud map.

In an embodiment, the function construction sub-module 3031 is configured to use the optimal estimation state as an initial value for matching between the point cloud data, and construct the cost function by using the optimal state, the uncertainty information corresponding to the optimal estimation state, and the constraint relationship between the point cloud data.

In an embodiment, FIG. 8 is a block diagram of a function construction sub-module 3031 according to this embodiment. The function construction sub-module includes a first function construction unit 30311, a second function construction unit 30312 and an accumulation unit 30313.

The first function construction unit 30311 is configured to use the optimal estimation state corresponding to the point cloud data as the initial value, and construct a first cost function according to a to-be-optimized state, the optimal estimation state corresponding to the point cloud data, and the uncertainty information corresponding to the optimal estimation state.

The second function construction unit 30312 is configured to construct a second cost function through to-be-optimized states of two adjacent frames of point cloud data and the uncertainty information corresponding to the optimal estimation state by using the constraint relationship between the point cloud data.

The accumulation unit 30313 is configured to accumulate the first cost function and the second cost function to obtain the final cost function.

In an embodiment, the vehicle body sensor data includes a vehicle body position, a vehicle body speed, a vehicle body acceleration, a vehicle body angular speed and a vehicle body forward direction speed; the optimal estimation state includes an optimal estimation position and an optimal estimation attitude; the optimal state includes an optimal position and an optimal attitude; and the to-be-optimized state includes a to-be-optimized position and a to-be-optimized attitude.

For limitations to the apparatus for constructing the point cloud map, reference may be made to the limitations to the method for constructing the point cloud map described above, which are not be repeated here. All or a part of multiple modules in the apparatus for constructing the point cloud map described above may be implemented by software, hardware and combination thereof. Each module described above may be embedded in or independent of a processor in a computer device in a hardware form, or stored in a memory in the computer device in a software form, so that the processor can invoke and execute operations corresponding to each module described above.

The apparatus for constructing the point cloud map provided above may be used for executing the method for constructing the point cloud map provided in any above embodiment and have corresponding functions and beneficial effects.

In an embodiment, a computer device is provided. The computer device may be a terminal. An internal structure diagram of the computer device may be as shown in FIG. 9. The computer device includes a processor, a memory, a network interface, a display screen and an input apparatus which are connected via a system bus. The processor of the computer device is configured to provide the calculation capability and the control capability. The memory of the computer device includes a non-volatile storage medium and an internal memory. The non-volatile storage medium stores an operation system and a computer program. The internal memory provides an environment for running the operation system and the computer program in the non-volatile storage medium. The network interface of the computer device is configured to communicate with an external terminal through a network connection. The computer program, when executed by the processor, implements a method for constructing a point cloud map. The display screen of the computer device may be a liquid crystal display screen or an electronic ink display screen. The input apparatus of the computer device may be a touch layer covered on the display screen, may be a key, a trackball or a touch pad disposed on a shell of the computer device, or may be an externally connected keyboard, touch pad, mouse or the like.

It is to be understood by those having ordinary skill in the art that the structure illustrated in FIG. 9 is merely a block diagram of a part of structures related to the schemes of the present application and does not limit the computer device to which the schemes of the present application are applied, and a computer device may include more or fewer components than those illustrated in FIG. 9, or may be a combination of some components, or may have a different layout of components.

In an embodiment, a computer device is provided. The computer device includes a memory and a processor. The memory stores a computer program. The processor, when executing the computer program, implements the method for constructing the point cloud data according to each embodiment described above.

In an embodiment, a computer-readable storage medium is provided. The computer-readable storage medium stores a computer program. The computer program, when executed by a processor, implements the method for constructing the point cloud data according to each embodiment described above.

It is to be understood by those having ordinary skill in the art that all or a part of the processes in the methods of the embodiments described above may be completed by instructing related hardware through a computer program, the computer program may be stored in a non-volatile and computer-readable storage medium, and during the execution of the computer program, the processes in the method embodiments described above may be implemented. All references to the memory, storage, database, or other media used in the various embodiments provided in the present application may each include a non-volatile and/or volatile memory. The non-volatile memory may include a read-only memory (ROM), a programmable ROM (PROM), an electrically programmable ROM (EPROM), an electrically erasable programmable ROM (EEPROM) or a flash memory. The volatile memory may include a random access memory (RAM) or an external cache memory. By way of illustration but not limitation, the RAM is available in multiple forms, such as a static RAM (SRAM), a dynamic RAM (DRAM), a synchronous DRAM (SDRAM), a dual data rate SDRAM (DDRSDRAM), an enhanced SDRAM (ESDRAM), a synchronous link (Synchlink) DRAM (SLDRAM), a memory bus (Rambus) direct RAM (RDRAM), a direct memory bus dynamic RAM (DRDRAM), a memory bus dynamic RAM (RDRAM) or the like.

The technical features of the embodiments described above may be combined in any way. For the brevity of description, not all possible combinations of the technical features in the embodiments described above are described. However, as long as the combinations of these technical features do not conflict, these combinations should be regarded to be within the scope of the specification.

The preceding embodiments are merely several implementation modes of the present application. These embodiments are described in a detailed manner but cannot be understood as a limitation to the scope of the present application. It is to be noted that for those having ordinary skill in the art, several improvements and modifications may further be made without departing from the principle concept of the present application, and these improvements and modifications are within the scope of the present application. Therefore, the scope of the present application is defined by the appended claims.

What is claimed is:

1. A method for constructing a point cloud map, comprising:
acquiring point cloud data and vehicle body sensor data corresponding to the point cloud data;
performing fusion processing on the vehicle body sensor data to obtain an optimal estimation state of the vehicle body sensor data and uncertainty information corresponding to the optimal estimation state; and
constructing the point cloud map corresponding to the point cloud data according to the optimal estimation state and the uncertainty information corresponding to the optimal estimation state.

2. The method of claim 1, wherein performing the fusion processing on the vehicle body sensor data to obtain the optimal estimation state of the vehicle body sensor data and the uncertainty information corresponding to the optimal estimation state comprises:
obtaining the optimal estimation state of the vehicle body sensor data through a Bayesian estimation method;
establishing an uncertainty model according to the vehicle body sensor data; and
obtaining, according to the uncertainty model, the uncertainty information corresponding to the optimal estimation state by using the Bayesian estimation method.

3. The method of claim 1, wherein constructing the point cloud map corresponding to the point cloud data according to the optimal estimation state and the uncertainty information corresponding to the optimal estimation state comprises:
constructing a cost function by using the optimal estimation state, the uncertainty information corresponding to the optimal estimation state, and a constraint relationship between the point cloud data;
optimizing the cost function by using a nonlinear optimization method to obtain an optimal state of the point cloud data; and
adjusting the point cloud data according to the optimal state of the point cloud data to construct the point cloud map.

4. The method of claim 3, wherein constructing the cost function by using the optimal estimation state, the corresponding uncertainty information, and the constraint relationship between the point cloud data comprises:
using the optimal estimation state as an initial value for matching between the point cloud data, and constructing the cost function by using the optimal state, the uncertainty information corresponding to the optimal estimation state, and the constraint relationship between the point cloud data.

5. The method of claim 4, wherein using the optimal estimation state as the initial value for the matching between the point cloud data, and constructing the cost function by using the optimal state, the uncertainty information corresponding to the optimal estimation state, and the constraint relationship between the point cloud data comprise:
using the optimal estimation state corresponding to the point cloud data as the initial value, and constructing a first cost function according to a to-be-optimized state, the optimal estimation state corresponding to the point cloud data, and the uncertainty information corresponding to the optimal estimation state;
constructing a second cost function through to-be-optimized states of two adjacent frames of the point cloud data and the uncertainty information corresponding to the optimal estimation state by using the constraint relationship between the point cloud data; and
accumulating the first cost function and the second cost function to obtain the final cost function.

6. The method of claim 1, wherein the vehicle body sensor data comprises a vehicle body position, a vehicle body speed, a vehicle body acceleration, a vehicle body angular speed and a vehicle body forward direction speed; the optimal estimation state comprises an optimal estimation position and an optimal estimation attitude; an optimal state comprises an optimal position and an optimal attitude; and a to-be-optimized state comprises a to-be-optimized position and a to-be-optimized attitude.

7.-8. (canceled)

9. A computer device, comprising a memory and a processor, wherein the memory is configured to store a computer program, and the processor is configured to, when executing the computer program, implement the following steps:
acquiring point cloud data and vehicle body sensor data corresponding to the point cloud data;
performing fusion processing on the vehicle body sensor data to obtain an optimal estimation state of the vehicle body sensor data and uncertainty information corresponding to the optimal estimation state; and
constructing the point cloud map corresponding to the point cloud data according to the optimal estimation state and the uncertainty information corresponding to the optimal estimation state.

10. A computer-readable storage medium, storing a computer program, wherein the computer program, when executed by a processor, implements the following steps:
acquiring point cloud data and vehicle body sensor data corresponding to the point cloud data;
performing fusion processing on the vehicle body sensor data to obtain an optimal estimation state of the vehicle body sensor data and uncertainty information corresponding to the optimal estimation state; and
constructing the point cloud map corresponding to the point cloud data according to the optimal estimation state and the uncertainty information corresponding to the optimal estimation state.

11. The computer device of claim 9, wherein the computer device implements performing the fusion processing on the vehicle body sensor data to obtain the optimal estimation state of the vehicle body sensor data and the uncertainty information corresponding to the optimal estimation state by:
obtaining the optimal estimation state of the vehicle body sensor data through a Bayesian estimation method;
establishing an uncertainty model according to the vehicle body sensor data; and
obtaining, according to the uncertainty model, the uncertainty information corresponding to the optimal estimation state by using the Bayesian estimation method.

12. The computer device of claim 9, wherein the computer device implements constructing the point cloud map corresponding to the point cloud data according to the optimal estimation state and the uncertainty information corresponding to the optimal estimation state by:
constructing a cost function by using the optimal estimation state, the uncertainty information corresponding to the optimal estimation state, and a constraint relationship between the point cloud data;
optimizing the cost function by using a nonlinear optimization method to obtain an optimal state of the point cloud data; and
adjusting the point cloud data according to the optimal state of the point cloud data to construct the point cloud map.

13. The computer device of claim 12, wherein the computer device implements constructing the cost function by using the optimal estimation state, the corresponding uncertainty information, and the constraint relationship between the point cloud data by:
using the optimal estimation state as an initial value for matching between the point cloud data, and constructing the cost function by using the optimal state, the uncertainty information corresponding to the optimal estimation state, and the constraint relationship between the point cloud data.

14. The computer device of claim 13, wherein the computer device implements using the optimal estimation state as the initial value for the matching between the point cloud data, and constructing the cost function by using the optimal state, the uncertainty information corresponding to the optimal estimation state, and the constraint relationship between the point cloud data by:
using the optimal estimation state corresponding to the point cloud data as the initial value, and constructing a first cost function according to a to-be-optimized state, the optimal estimation state corresponding to the point cloud data, and the uncertainty information corresponding to the optimal estimation state;
constructing a second cost function through to-be-optimized states of two adjacent frames of the point cloud data and the uncertainty information corresponding to the optimal estimation state by using the constraint relationship between the point cloud data; and
accumulating the first cost function and the second cost function to obtain the cost function.

15. The computer device of claim 9, wherein the vehicle body sensor data comprises a vehicle body position, a vehicle body speed, a vehicle body acceleration, a vehicle body angular speed and a vehicle body forward direction speed; the optimal estimation state comprises an optimal estimation position and an optimal estimation attitude; an optimal state comprises an optimal position and an optimal attitude; and a to-be-optimized state comprises a to-be-optimized position and a to-be-optimized attitude.

16. The computer-readable storage medium of claim 10, wherein the computer program implements performing the fusion processing on the vehicle body sensor data to obtain the optimal estimation state of the vehicle body sensor data and the uncertainty information corresponding to the optimal estimation state by:
obtaining the optimal estimation state of the vehicle body sensor data through a Bayesian estimation method;
establishing an uncertainty model according to the vehicle body sensor data; and
obtaining, according to the uncertainty model, the uncertainty information corresponding to the optimal estimation state by using the Bayesian estimation method.

17. The computer-readable storage medium of claim 10, wherein the computer program implements constructing the point cloud map corresponding to the point cloud data according to the optimal estimation state and the uncertainty information corresponding to the optimal estimation state by:
constructing a cost function by using the optimal estimation state, the uncertainty information corresponding to the optimal estimation state, and a constraint relationship between the point cloud data;
optimizing the cost function by using a nonlinear optimization method to obtain an optimal state of the point cloud data; and
adjusting the point cloud data according to the optimal state of the point cloud data to construct the point cloud map.

18. The computer-readable storage medium of claim 17, wherein the computer program implements constructing the cost function by using the optimal estimation state, the corresponding uncertainty information, and the constraint relationship between the point cloud data by:
using the optimal estimation state as an initial value for matching between the point cloud data, and constructing the cost function by using the optimal state, the uncertainty information corresponding to the optimal estimation state, and the constraint relationship between the point cloud data.

19. The computer-readable storage medium of claim 18, wherein the computer program implements using the optimal estimation state as the initial value for the matching between the point cloud data, and constructing the cost function by using the optimal state, the uncertainty information corresponding to the optimal estimation state, and the constraint relationship between the point cloud data by:
using the optimal estimation state corresponding to the point cloud data as the initial value, and constructing a first cost function according to a to-be-optimized state, the optimal estimation state corresponding to the point cloud data, and the uncertainty information corresponding to the optimal estimation state;
constructing a second cost function through to-be-optimized states of two adjacent frames of the point cloud data and the uncertainty information corresponding to the optimal estimation state by using the constraint relationship between the point cloud data; and
accumulating the first cost function and the second cost function to obtain the cost function.

20. The computer-readable storage medium of claim 10, wherein the vehicle body sensor data comprises a vehicle body position, a vehicle body speed, a vehicle body acceleration, a vehicle body angular speed and a vehicle body forward direction speed; the optimal estimation state comprises an optimal estimation position and an optimal estimation attitude; an optimal state comprises an optimal position and an optimal attitude; and a to-be-optimized state comprises a to-be-optimized position and a to-be-optimized attitude.
